(19) United States
(12) Patent Application Publication
(10) Pub. No.: US 2003/0007013 A1
(43) Pub. Date: Jan. 9, 2003

(54) Composite document editor

(76) Inventor: Peter Gatis, Mississauga (CA)

Correspondence Address: PAUL A. PYSHER, Fish & Richardson P.C., 225 Franklin Street, Boston, MA, 02110-2804, US

(21) Appl. No.: 09/900,984

(22) Filed: Jul. 9, 2001

(51) Int. Cl. G09G 5/00

(52) U.S. Cl. 345/853

(57) ABSTRACT

A graphical user interface (GUI) is used for viewing a composite document comprised of separate documents having an ordered relationship. The GUI includes an area for displaying the separate documents and a control for use in selecting the separate documents for display in accordance with the ordered relationship. The GUI may also include a feature for altering the ordered relationship of the separate documents.

### TECHNICAL FIELD

This invention relates to a composite document editor and a computer program for generating the composite document editor.

### BACKGROUND

Document editors currently exist for editing “simple” documents. A simple document is an unordered or partially ordered document that is treated as a unit and that cannot be separated into constituent parts without creating separate files. An example of a simple document is a word processing file, such as a Microsoft® Word® file. Document editors typically enable users to change the content or format of simple documents. Also, document editors enable users to create new documents and to edit those accordingly.

### SUMMARY

In general, in one aspect, the invention is directed to a graphical user interface (GUI) for viewing a composite document comprised of separate documents having an ordered relationship. The GUI includes an area for displaying the separate documents and a control for use in selecting the separate documents for display in accordance with the ordered relationship. This aspect of the invention may include one or more of the following features.

The control may include a scroll bar for scrolling through the separate documents, a tree structure having the separate documents as selectable branches, one or more buttons for scrolling through the separate documents, and/or one or more tabs for selecting the separate documents. The GUI may include a feature for altering the ordered relationship of the separate documents, such as a drag bar attached to one of the separate documents for dragging and dropping the document to a new position relative to others of the separate documents.

The GUI may include a notes section for adding notations relating to at least one of the separate documents and/or an options section for displaying one or more options that can be performed on the separate documents. The one or more options may include an option to print one of the separate documents.

Any of the separate documents may head a hierarchy of subdocuments. The GUI may include an area for displaying this hierarchy. The subdocuments may be displayed to reflect a hierarchical relationship to one of the separate documents. The GUI may include an area for displaying identifying information for the separate documents. The separate documents may include one or more of a word processing document, an image, and a spreadsheet. The GUI may include options for editing the separate documents.

The GUI may include an area for displaying conjoined subdocuments prior to printing. The GUI may display options for editing the conjoined subdocuments prior to printing. In this aspect, edits made to the conjoined subdocuments revert to the original subdocuments for further editing, display, or storage.

Other features and advantages of the invention will become apparent from the following description, including the claims and drawings.

### DESCRIPTION OF THE DRAWINGS

FIG. 1 is a block diagram of a composite document.

FIGS. 2 to 7 and 9 are graphical user interfaces (GUIs) for embodiments of a composite document editor.

FIG. 8 is a block diagram of a computer system on which the composite document editors of FIGS. 1 to 7 and 9 may be implemented.

### DESCRIPTION

For the purposes of this application, a composite document is an ordered set of simple documents. More specifically, if a text bock is defined to be an unordered set of characters, symbols, paragraphs, dates, figures, and embedded visual objects of whatever type, and irrespective of any color, font, style or formatting that may be applied, then a subdocument is an unordered or partially ordered set of text blocks. A composite document then, is an arbitrarily ordered set of subdocuments in which (1) an ordering relationship exists as a distinct entity independently of any text block and (2) the set of subdocuments are in some way manipulated as a unit according to that ordering relationship.

Stated otherwise, a composite document is a fragmented set of subdocuments conjoined into a whole by virtue of an ordering relationship. When the subdocuments are conjoined by an editor, no lines, paragraphing, or white-space are added or subtracted unless specifically indicated by user options. For example, three subdocuments comprised of worksheets, figures, and paragraphs may be joined to produce a one page composite document. If an audit display is included in the editor, the three subdocuments could be shown as a single page document seamlessly assembled from the subdocuments in the specified order.

In another example, a composite document may include one or more ordered word-processing documents, images, spreadsheets, etc. Constituent parts of the composite document (e.g., the subdocuments) may exist as separate computer files that have a relationship to one another that is defined by data in the composite document. The separate computer files may be in a common format, such as rich text format (RTF), although the composite document editor does not require use of a common format. It is noted that there is no particular need for the subdocuments to exist as separate files. In one embodiment of the composite document editor, the ordering relation and associated subdocuments exist as ordered “blobs” (which stands for “binary large objects”) in a single compressed database file for convenient persistent storage. If an external document such as a diagram is included, it would be copied and pasted to an existing subdocument, or inserted directly as a new subdocument from a file.

In general, then, a composite document editor is a device that creates or edits such composite documents, where the final assembled document includes all or some of the constituent subdocuments conjoined seamlessly in the order given by the user-defined ordering relation.

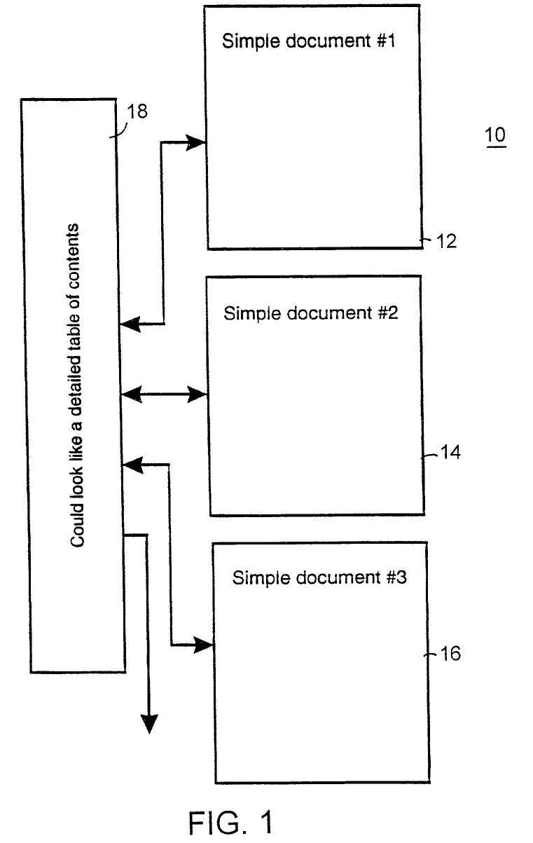

By way of example, as shown in FIG. 1, composite document 10 may include simple documents 12, 14, and 16 that are arranged in order, as shown, from document 12 to document 16. The ordering may be representative of the contents of the composite document. For example, simple documents 12 to 16 may be word processing files representing chapters of a book defined by composite document 10. Illustrations, e.g., images, for the book may also be included as separate simple documents. The ordering relationship itself may be stored as a simple document 18, such as a table of contents, which references the other simple documents. In one embodiment, the ordering relation is stored as four columns in a database table. The first column provides a unique subdocument identifier (ID), the second column provides a sequential index, the third column provides hierarchical depth, and the fourth column provides a human-readable descriptor.

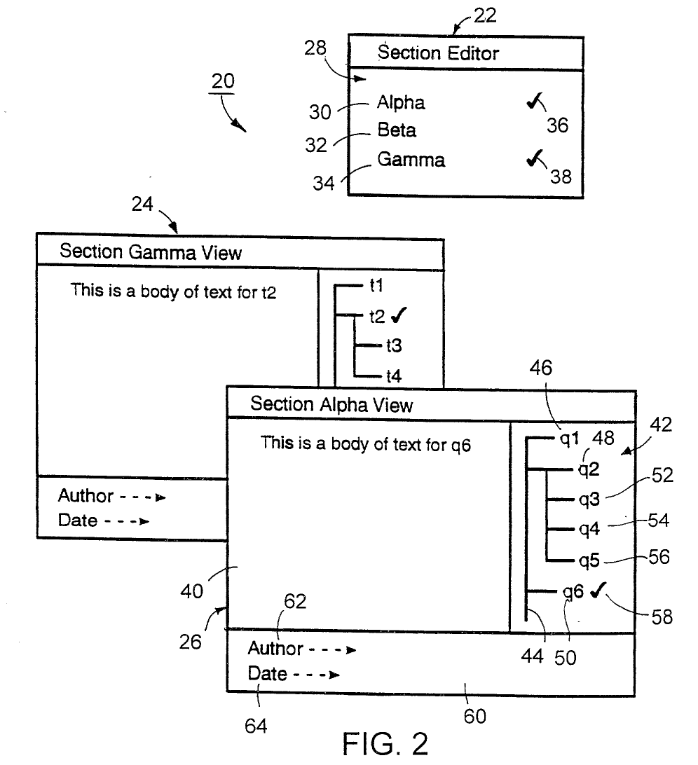

Referring to FIG. 2, a graphical user interface (GUI) 20 is shown for one embodiment of a composite document editor. GUI 20 includes three windows 22, 24 and 26, although any number of windows may be included. Window 22 displays sections 28 of a composite document. Here, the sections are labeled “alpha” 30, “beta” 32 and “gamma” 34. Each section of the composite document is comprised of one or more simple documents in a user-modifiable arrangement. The ordering relation (the user-modifiable arrangement) is kept separate from all simple documents but would normally be visible and include hierarchical data about the ordering of those simple documents. Thus, each section may be considered a composite document itself.

In this embodiment, a composite document does not include subdocuments that are themselves composite documents, although the invention does not preclude using composite documents as subdocuments. In this embodiment, by definition, a subdocument is a simple document, not a composite document. If an external composite document were to be introduced into an existing composite document, the external document would show up as a new section or set of sections. If an external composite document were forced in as part of the ordering “tree”, a merger of the ordering relations would first occur to prevent entanglement of ordering relations existing at different levels. As it is, the ordering relation proper is linear, with hierarchical depth added for viewing convenience. The depth is part of the ordering relation, not part of any subdocument. Generally speaking, the hierarchical depth does not show up in the final assembled document.

Selecting a section from window 22 displays a corresponding window for that section. A check mark 36 and 38 (or other indication) may be displayed next to a selected section. In the example shown in FIG. 2, alpha section 30 and gamma section 34 are selected.

Window 26 corresponds to alpha section 30. Window 26 contains a display area 40 for displaying the contents of each separate subdocument included in alpha section 30. Those subdocuments are shown in control area 42. Control area 42 contains a tree structure 44, which depicts the ordered relationship of subdocuments that make-up alpha section 30. In more detail, tree structure 44 shows that alpha section 30 includes subdocuments q1 46, q2 48, q3 52, q4 54, q5 56, and q6 50 such that q3 52, q4 54, and q5 56 are subordinate to subdocument q2 48 in the hierarchy established by the ordering relation. If alpha section 30 were printed or placed in an audit view, the subdocuments q1 46, q2 48, q3 52, q4 54, q5 56, and q6 50 would be seamlessly conjoined in sequential order, and the hierarchy would disappear. The hierarchy appears in the ordering relation as a matter of convenience.

Control area 42 is so labeled because a user can select branches of tree structure 44, i.e., the separate documents, for display in display area 40 while still preserving the ordered relationship of the subdocuments. For example, a user can point and click on any of the subdocuments displayed in tree structure 44 using, e.g., a mouse or other device. Selecting one of the subdocuments results in the contents of the selected subdocument being displayed in display area 40. For example, in window 26, subdocument q6 50 is selected and its contents displayed in display area 40. A check mark 58 (or other indication) may be displayed next to the selected subdocument q6 50.

Window 26 may also include an area 60 for displaying identification information relating to alpha section 30. In this embodiment, area 60 includes the identity of the author 62 of alpha section 30 and the date 64 on which alpha section 30 was created. Other information may also be included in area 60, if desired.

A window 24 is displayed for gamma section 34, which is also selected in window 22, as indicated by check mark 38. Window 24 for gamma section 34 contains substantially the same information as window 26 for alpha section 30, with the various subdocuments of gamma section 38 being labeled with “t's” instead of “q's”.

Although the ordered relationship of the subdocuments included in the composite document is preserved during display, the ordering may be modified. That is, via GUI 20, a user can select a subdocument, such as subdocument q6 50 on tree structure 44, and move that subdocument relative to other subdocuments on tree structure 44. For example, subdocument q6 50 can be moved so that it immediately follows subdocument q1 46. Similarly, subdocuments can be moved from one section to another section. Thus, it is possible to move subdocument q6 50 from alpha section 30 to gamma section 34 simply by dragging and dropping document q6 50 using a mouse or other peripheral device.

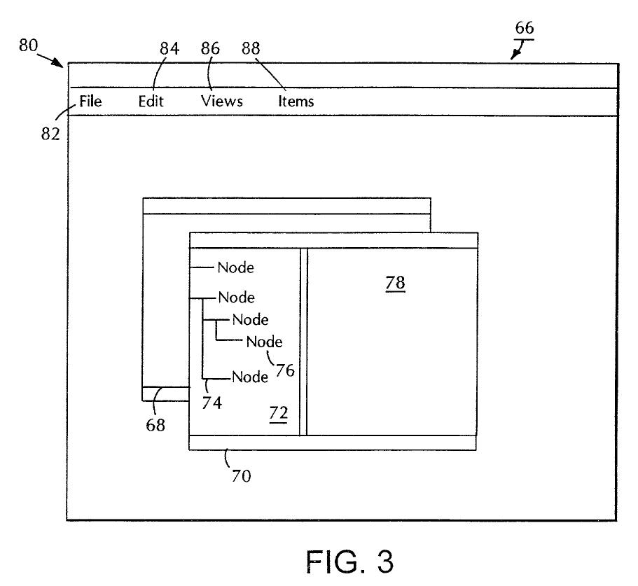

FIG. 3 shows a screen shot 66 that roughly corresponds to the embodiment of FIG. 2. Screen shot 66 shows windows 68 and 70, which roughly correspond to windows 24 and 26, respectively, of FIG. 2. Window 70, for example, does not include the identification section 60 in window 26, but it does include control area 72 with a tree structure 74 and subdocuments, i.e., nodes 76. Window 70 also includes a display area 78 for displaying contents of the subdocuments displayed in control area 72.

Options 80 are provided in the composite document editor for editing and manipulating the composite document displayed in windows 68, 70, or its individual parts. In this embodiment, file option 82 includes print document, audit document, save document, and open document. Print document prints the entire composite document or selected subdocuments thereof. Audit document displays one or more selected subdocuments conjoined for editing. Save document saves a currently open composite document in its entirety. Open document opens an existing selected composite document or can be used to create a new composite document. Edit option 84 includes options for editing a composite document, such as “copy”, “paste”, “add”, “delete”, etc. Views option 86 contains options for viewing the composite document. Items option 88 contains options for dealing with individual subdocuments. The Items menu is similar to the File menu. The Items menu can be used to Add, Delete, or Rename a subdocument, as well as to expand or to collapse the hierarchy of subdocuments.

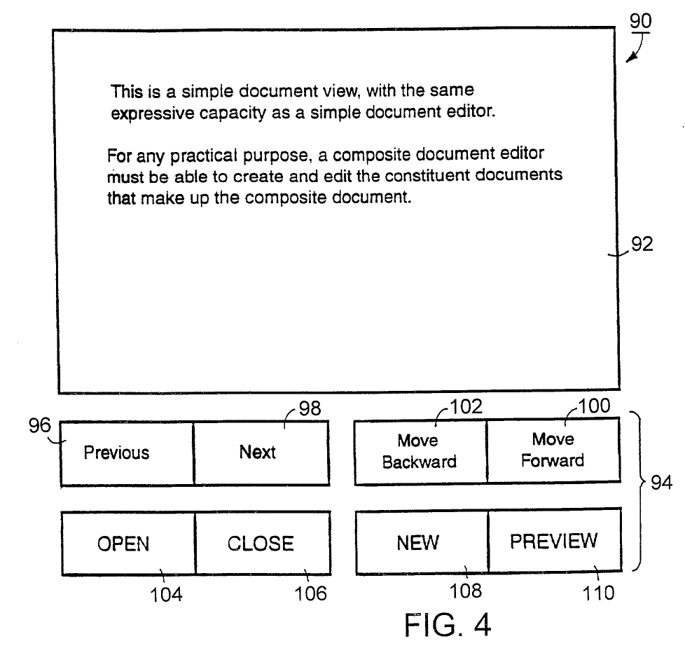

Referring to FIG. 4, another embodiment of a GUI for a composite document editor 90 is shown. This embodiment includes a display area 92 for displaying a composite document and separate subdocuments that are included within the composite document, much like index cards. The subdocuments can be displayed in the way that they are ordered in the composite document. That is, each separate subdocument may be displayed, in sequence, in area 92. Controls 94 are provided for viewing and editing the composite document.

Controls 94 include Previous button 96 and Next button 98. Previous button 96 scrolls through an internal list of subdocuments to display, in area 92, the previous subdocument in the list. Next button 98 scrolls through the internal list of subdocuments to display, in area 92, the next subdocument in the list. Move Forward button 100 moves the current subdocument forward one position in the list. Move Backward button 102 moves the current subdocument backward one position in the internal list. Open button 104 opens a current composite document and displays a first subdocument in that composite document in area 92. Close button 106 closes a currently open composite document. New button 108 creates a new subdocument. Preview button 110 executes a print preview operation on a currently open composite document in area 92. Not shown is means to delete subdocuments, and numbering of the subdocuments for purposes of ordering through the Move Forward and Move Backward buttons.

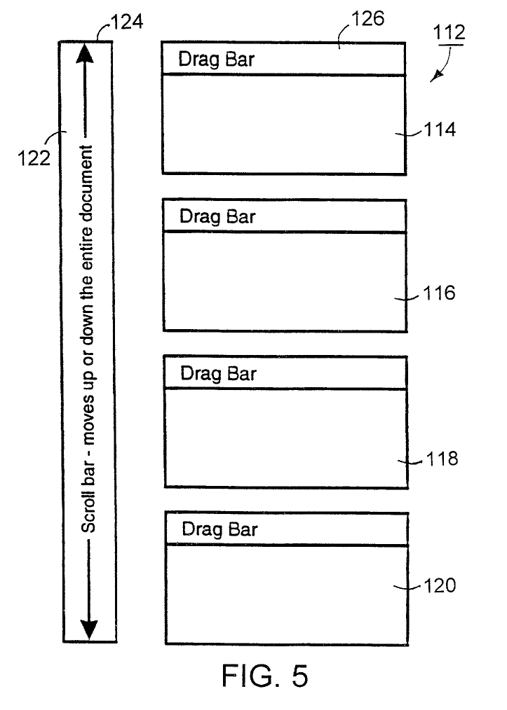

Referring to FIG. 5, another embodiment of a GUI for a composite document editor 112 is shown. This embodiment includes multiple display areas 114 to 120 for displaying the separate subdocuments that are included within a composite document. Although only four display areas are shown, any number of display areas may be depicted at the same time. Each display area displays the contents of a separate subdocument. Together, the subdocuments make up a single composite document. A scroll bar control 122 is provided for scrolling through the various subdocuments. For example, clicking on the top 124 of scroll bar 122 moves display 116 into the position currently occupied by display 114, display 118 into the position currently occupied by display 116, and display 120 into the position currently occupied by display 118. A new display (not shown) is then moved into the position currently occupied by display 120.

During scrolling, the displays are depicted in the order that the subdocuments exist in the composite document. However, they may be reordered using a feature, such as drag bar 126. That is, a user may select drag bar 126 using a mouse or other peripheral device, and drag display 114 to any other location relative to the other displays. This causes the subdocument represented by display 114 to be repositioned within the structure of the composite document.

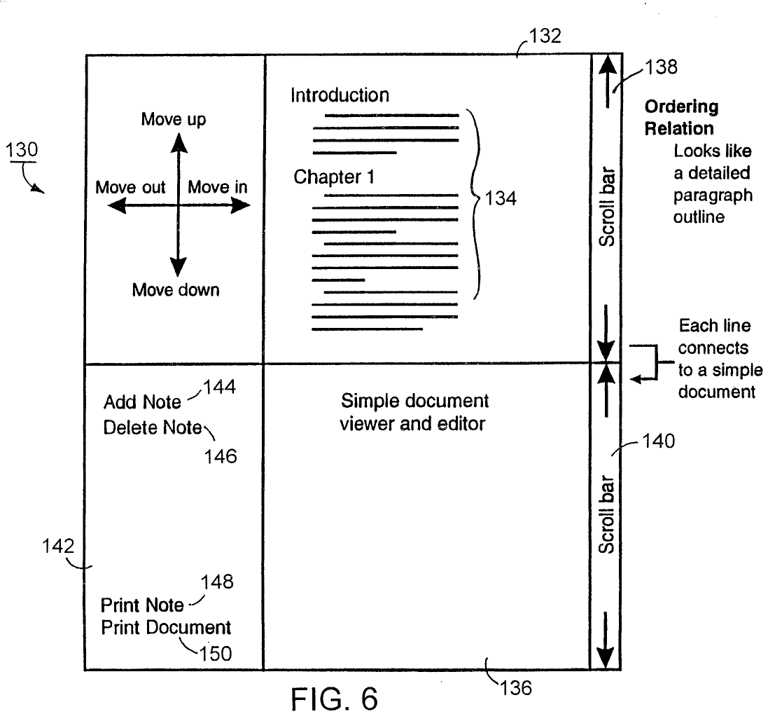

Referring to FIG. 6, another embodiment of a GUI for a composite document editor 130 is shown. Composite document editor 130 contains area 132 for displaying a list 134 of subdocuments that make up a composite document. The list 134 of subdocuments may be chapter headers, or the like, such as a table of contents. A subdocument in list 134 may be selected by pointing and clicking using a mouse or other computer peripheral device. The content of a selected subdocument is displayed in area 136.

Scroll bar 138 allows the user to scroll through list 134 in the order that the subdocuments are kept in the composite document. Scroll bar 140 allows the user to scroll through a selected subdocument. A mouse or other computer peripheral may be used to effect scrolling.

Area 142 contains options for adding 144 and deleting 146 subdocuments to the composite document. In this case, each subdocument is simply a “note”. Area 142 also contains options 148 and 150 for, respectively, printing a note and printing the entire document. The Move Up and Move Down arrows allow for the re-ordering of subdocuments (notes) within the composite document. The Right and Left arrows allow for the descriptors of the subdocuments (notes) to be arranged in an indented hierarchy.

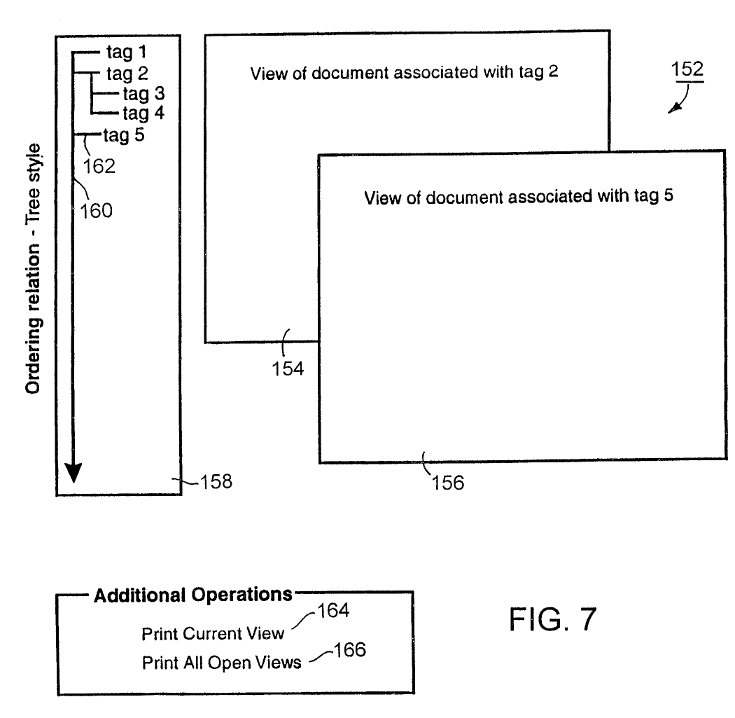

Referring to FIG. 7, another embodiment of a composite document editor 152 is shown. This embodiment includes multiple display areas 154 and 156 for displaying the contents of a selected composite document. Composite document editor 152 also includes a control area 158.

Control area 158 contains a tree structure 160, which depicts the ordered relationship of the subdocuments that make-up a composite document. Control area 158 is so labeled because a user can select branches of the tree structure, i.e., the separate documents (here labeled “tags”), for display in a display area 154, 156 without disturbing the ordered relationship of the subdocuments.

By way of example, a user can point and click on any of the subdocuments displayed in tree structure 160 using, e.g., a mouse or other device. Selecting one of the subdocuments results in the contents of the selected subdocument being displayed in a display area. For example, in control area 158, subdocument 162 is selected and its content is displayed in display area 156.

Composite document editor 152 also displays option 164 for printing a current view, e.g., for printing display 156 but not display 154 (the display in front is considered to be the current view). Option 166 prints all open views, in this case, displays 154 and 156. Generally speaking, the entire subdocument is printed.

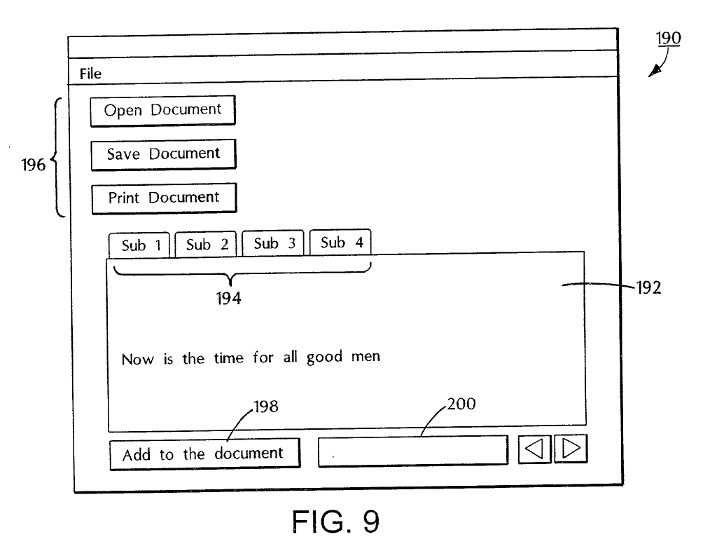

Referring to FIG. 9, another embodiment of a composite document editor 190 is shown. This embodiment includes a single display area 192 and tabs 194 for selecting a subdocument of a composite document to be displayed in display area 190. Options 196, including “open document”, “save document”, and “print document”, are provided for viewing and editing a subdocument displayed in area 192. Option 198 adds a subdocument to the current composite document (resulting in a new tab for that subdocument). Option 200 removes a subdocument and its tab.

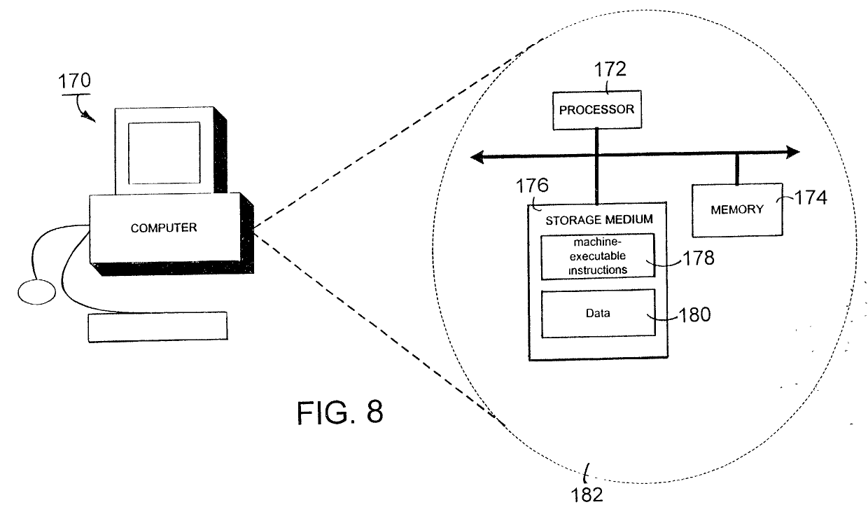

FIG. 8 shows a computer 170 for executing computer instructions to generate a composite document editor, such as those shown in FIGS. 2 to 7 and 9. Computer 170 includes a processor 172, a memory 174, and a storage medium 176 (see view 182). Storage medium 176 stores data 178 for one or more composite documents and machine-executable instructions 180 that are executed by processor 172 out of memory 174 to implement a composite document editor according to one (or more) of FIGS. 2 to 7 and 9.

Although a personal computer is shown in FIG. 8, a composite document editor is not limited to use with the hardware and software of FIG. 8. It may find applicability in any computing or processing environment. The composite document editor may be implemented using hardware (e.g., an ASIC {Application-Specific Integrated Circuit} and/or an FPGA {Field Programmable Gate Array}), software, or a combination of hardware and software.

The composite document editor may be implemented using one or more computer programs executing on programmable computers that each includes a processor, a storage medium readable by the processor (including volatile and nonvolatile memory and/or storage elements), at least one input device, and one or more output devices.

Each such program may be implemented in a high level procedural or object-oriented programming language to communicate with a computer system. Also, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to run the composite document editor.

The composite document editor may also be implemented as a computer-readable storage medium, configured with a computer program, where, upon execution, instructions in the computer program cause the computer to generate the composite document editor.

The invention is not limited to the specific embodiments described herein. For example, additional options may be provided on each embodiment to perform additional editing functions, such as adding and deleting text, creating outlines, etc. Basically, any function that is available on a simple document editor can be incorporated into the composite document editor. Examples of those functions include, but are not limited to, starting a new document, opening an existing document, editing a document in view, saving a document in view, renaming a document in view, discarding a document in view, printing an entire document, and/or viewing the entire document. The composite document editor is also not limited to the specific GUIs set forth herein. Other GUIs may be used to implement the same functionality.

Other embodiments not specifically described herein are also within the scope of the following claims.

What is claimed is:

1. A graphical user interface (GUI) for viewing a composite document comprised of separate documents having an ordered relationship, the GUI comprising:
an area for displaying the separate documents; and
a control for use in selecting the separate documents for display in accordance with the ordered relationship.

2. The GUI of claim 1, wherein the control comprises a scroll bar for scrolling through the separate documents.

3. The GUI of claim 1, wherein the control comprises a tree structure having the separate documents as selectable branches.

4. The GUI of claim 1, wherein the control comprises one or more buttons for scrolling through the separate documents.

5. The GUI of claim 1, wherein the control comprises one or more tabs for selecting the separate documents.

6. The GUI of claim 1, further comprising a feature for altering the ordered relationship of the separate documents.

7. The GUI of claim 6, wherein the feature comprises a drag bar attached to one of the separate documents for dragging and dropping the document to a new position relative to others of the separate documents.

8. The GUI of claim 1, further comprising a notes section for adding notations relating to at least one of the separate documents.

9. The GUI of claim 1, further comprising an options section for displaying one or more options that can be performed on the separate documents.

10. The GUI of claim 9, wherein the one or more options comprises an option to print one of the separate documents.

11. The GUI of claim 1, wherein one of the separate documents heads a hierarchy of subdocuments, and the GUI further comprises an area for displaying that hierarchy.

12. The GUI of claim 11, wherein subdocuments are displayed to reflect a hierarchical relationship to the one of the separate documents.

13. The GUI of claim 1, further comprising an area for displaying identifying information for the separate documents.

14. The GUI of claim 1, wherein the separate documents comprise one or more of a word processing document, an image, and a spreadsheet.

15. The GUI of claim 1, further comprising options for editing the separate documents.

16. A computer program stored on a computer-readable medium for viewing a composite document comprised of separate documents having an ordered relationship, the computer program comprising executable instructions that cause a machine to:
generate an area to display the separate documents; and
generate a control to select the separate documents for display while preserving the ordered relationship.

17. The computer program of claim 16, wherein the control comprises a scroll bar for scrolling through the separate documents.

18. The computer program of claim 16, wherein the control comprises a tree structure having the separate documents as selectable branches.

19. The computer program of claim 16, wherein the control comprises one or more buttons for scrolling through the separate documents.

20. The computer program of claim 16, wherein the control comprises one or more tabs for selecting the separate documents.

21. The computer program of claim 16, further comprising instructions to generate a feature for altering the ordered relationship of the separate documents.

22. The computer program of claim 21, wherein the feature comprises a drag bar attached to one of the separate documents for dragging and dropping the document to a new position relative to others of the separate documents.

23. The computer program of claim 16, further comprising instructions to generate a notes section for adding notations relating to at least one of the separate documents.

24. The computer program of claim 16, further comprising instructions to generate an options section for displaying one or more options that can be performed on the separate documents.

25. The computer program of claim 24, wherein the one or more options comprises an option to print one of the separate documents.

26. The computer program of claim 16, wherein one of the separate documents heads a hierarchy of subdocuments, and the computer program further comprises instructions to generate an area for displaying the hierarchy.

27. The computer program of claim 26, wherein subdocuments are displayed to reflect a hierarchical relationship to the one of the separate documents.

28. The computer program of claim 16, further comprising instructions to generate an area for displaying identifying information for the separate documents.

29. The computer program of claim 16, wherein the separate documents comprise one or more of a word processing document, an image, and a spreadsheet.

30. The computer program of claim 16, further comprising instructions to generate options for editing the separate documents.

31. An apparatus for displaying a graphical user interface (GUI) for viewing a composite document comprised of separate documents having an ordered relationship, the apparatus comprising:
a memory that stores executable instructions; and
a processor that executes the instructions to:
generate an area for displaying the separate documents; and
generate a control for selecting the separate documents for display while preserving the ordered relationship.

32. The GUI of claim 1, further comprising an area for displaying conjoined subdocuments prior to printing.

33. The GUI of the claim 32, further comprising displaying options for editing the conjoined subdocuments prior to printing.

34. The GUI of the claim 33, wherein edits made to the conjoined subdocuments revert to the original subdocuments for further editing, display, or storage.
